(19) United States
(12) Patent Application Publication
(10) Pub. No.: US 2003/0163957 A1
(43) Pub. Date: Sep. 4, 2003

(54) Coating process and abrasive articles made therewith

(75) Inventor: Pei-Jung Chen, London (CA)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/318,646

(22) Filed: Dec. 13, 2002

(30) Foreign Application Priority Data
Jan. 16, 2002 (CA) 2367898

(51) Int. Cl. B24D 3/00; B24D 11/00; B24D 18/00; B24D 3/28; B05D 3/02

(52) U.S. Cl. 51/298; 51/295; 51/293; 51/297; 427/385.5

(57) ABSTRACT

A process for coating a surface which comprises applying a composition comprising an amine aldehyde resin, a reactant bearing carboxylic acid groups or derivatives thereof and a Lewis acid, followed by thermal curing. The process is of value, for example, in the manufacture of abrasive products, where the composition serves as a make composition or size composition, or both, to hold abrasive particles on the surface of a backing.

The present invention relates to the application of a coating to a surface. The coating may be, for example, a binder coating that is a make coating or a size coating used to bond abrasive particles to a backing to form abrasive products.

### RELATED APPLICATION

This application claims priority from Canadian Application No. 2367898, filed on Jan. 16, 2002.

### BACKGROUND OF THE INVENTION

Coated abrasives generally comprise a flexible backing upon which a binder holds and supports a coating of abrasive grains. Backings include paper, cloth, film, vulcanized fiber, and combinations, and treated versions thereof. The abrasive grains include those made of flint, garnet, aluminum oxide, ceramic aluminum oxide, alumina zirconia, diamond, and silicon carbide. Binders are commonly selected from phenolic resins, hide glue, urea-formaldehyde resins, urethane resins, epoxy resins, and varnish. Urea-formaldehyde resins have been commonly used as adhesive resins in wood-based panel production and in abrasive manufacturing.

The coated abrasive may employ a “make” coat of resinous binder material in order to secure the abrasive grains to the backing, and a “size” coat of resinous binder material can be applied over the make coat and abrasive grains in order to firmly bond the abrasive grains to the backing. The binder material of the size coat can be the same material as the binder material of the make coat or of a different material.

In the manufacture of coated abrasives, the make coat and abrasive grains are first applied to the backing, then the size coat is applied, and finally, the construction is fully cured. Generally, thermally curable binders provide coated abrasives with excellent properties including heat resistance. Thermally curable binders include phenolic resins, urea-formaldehyde resins, urethane resins, melamine-formaldehyde resins, epoxy resins, and alkyd resins.

U.S. Pat. No. 5,236,472 (Kirk, et al.) is concerned with making abrasive articles comprising abrasive grains and at least one binder formed from a mixture of radiation curable resins and thermally curable resins. Radiation curable resins are generally expensive, however, and for some applications increased cost cannot be tolerated.

U.S. Pat. No. 5,486,219 (Ford, et al.) (the '219 patent) uses a binder precursor composition comprising a urea-aldehyde resin and a cocatalyst in the manufacture of abrasive articles. The cocatalyst used in the '219 patent comprises a Lewis acid and an organic amine or an ammonium salt.

U.S. Pat. No. 5,914,365 (Chang, et al.) discloses an aqueous binder composition containing a urea-formaldehyde resin modified with a water-soluble styrene-maleic anhydride copolymer which is cured by heating at a temperature of at least 170° C., but may include less desirably a Brönsted acid catalyst such as ammonium chloride or p-toluene sulfonic acid. A Brönsted acid is a proton donor whereas a Lewis acid is a compound that accepts an electron pair which it shares with the electron pair donated by a Lewis base.

### SUMMARY OF THE INVENTION

In one aspect, the invention provides a process for coating a surface which comprises applying a composition comprising an amine-aldehyde resin, a reactant bearing carboxylic acid groups or derivatives thereof, and a Lewis acid onto the surface. The coated substrate can be subjected to a thermal curing step. The process is particularly suited for use in making coated abrasives, but can be used for many other purposes that involve applying a coating to a surface.

In a second aspect, the invention provides a coated abrasive having a binder and abrasive particles attached to a backing, wherein at least one layer of the binder comprises a cured binder derived from a coatable binder precursor composition comprising an amine-aldehyde resin, a reactant bearing carboxylic acid groups or derivatives thereof and a Lewis acid.

In a third aspect, the invention provides a process for making a coated abrasive article, the method comprising:

(a) applying a first layer comprising a first curable composition onto a surface of a backing;

(b) at least partially embedding abrasive grains into the first layer;

(c) at least partially curing the first curable composition;

(d) applying a second layer comprising a second curable composition over the first at least partially cured curable composition and abrasive grains; and

(e) curing the second curable composition

wherein at least one of the first or second curable compositions is a coatable binder precursor composition comprising an amine-aldehyde resin, a reactant bearing carboxylic acid groups or derivatives thereof, and a Lewis acid.

### DETAILED DESCRIPTION

The composition comprising an amine-aldehyde resin, a reactant bearing carboxylic acid groups or derivatives thereof, and a Lewis acid is preferably used as a coatable binder precursor composition in the process of the invention. The invention will be further described with reference to this preferred embodiment. It should be appreciated, however, that the composition can be used in other ways.

The term “coatable”, as used herein, means that the binder precursor compositions of the invention may be easily coated or sprayed onto substrates using coating devices which are conventional in the abrasives art, such as knife coaters, roll coaters, flow-bar coaters, electrospray coaters, and the like. This characteristic may also be expressed in terms of viscosity of the binder precursor compositions. The viscosity of the coatable binder precursor compositions desirably should not exceed about 2000 centipoise (cps) (2 Pa.s), measured using a BROOKFIELD viscometer, number 3 spindle, 30 rpm, at room temperature (about 25° C.). More preferably, the viscosity should range from about 70 to about 900 cps (0.07 to 0.9 Pa.s). A preferred “coatable binder precursor composition” is a coatable, homogeneous mixture including uncured amine-aldehyde resin, a reactant bearing carboxylic acid groups or derivatives thereof, a Lewis acid and water, which, upon curing, becomes a binder. The term “binder” means a cured binder.

In a preferred embodiment, an aqueous composition of the amine-aldehyde precursor composition, an aqueous composition of a reactant bearing carboxylic acid groups or derivatives thereof, and an aqueous composition of a Lewis acid catalyst are sprayed so that they meet in a region adjacent to the surface, where they mix, and the mixture deposits on the surface. Alternatively, or in addition, the components may be sprayed so that they mix at or on the surface. As the catalyst and the amine-aldehyde precursor composition do not meet until they are being applied to the surface, problems caused by premature hardening of the binder precursor composition in kettles, piping, pump valves and the like are avoided.

The aqueous composition of each reactant or catalyst used in this invention may be a solution, emulsion, dispersion or suspension.

The aqueous composition of the reactant bearing carboxylic acid groups or derivatives thereof may be admixed with the aqueous composition of the amine-aldehyde resin composition, so that there are two sprays that encounter each other, the one being this aqueous composition and the other being the aqueous composition of the Lewis acid. Alternatively, one composition contains the amine-aldehyde resin and the other composition contains the reactant bearing carboxylic acid groups or derivatives thereof and the Lewis acid. It is possible to use three sprays, however, one containing the amine-aldehyde resin composition, one containing the composition of the reactant bearing carboxylic acid groups or derivatives thereof and one containing the aqueous composition of Lewis acid. Of course, there can be any number of nozzles for the provision of each sprayed solution or suspension. When speaking of the number of sprays we are not limiting the physical arrangement of apparatus used to carry out the process of the invention.

The invention is of particular value in the manufacture of abrasive products. Typically there is applied a make coating to a backing of paper, cloth or the like. The adhesive particles are bound to each other and to the backing by the applied composition which serves as the make coating. Frequently there is applied a further coating, a size coating, to assist in the binding of the abrasive particles. The sprayed coatings of the invention can serve as make coating, or size coating, or both.

The amine-aldehyde resins are suitably resins of urea-formaldehyde, melamine-formaldehyde, or melamine-phenol-formaldehyde, or mixtures thereof.

The amine-aldehyde resin of the binder precursor composition is typically a product of the condensation copolymerization reaction of an aldehyde with urea and/or urea derivatives, otherwise known as a urea-aldehyde resin. The urea-aldehyde resin preferably has an aldehyde: urea molar ratio of at least 1.0:1 and more preferably in the range from about 1.0:1 to about 2.0:1, and a “free aldehyde” content in the range from about 0.1 to about 3.0 weight percent, more preferably about 0.1 to about 1.0 weight percent, based on the weight of original aldehyde. “Free aldehyde” means the weight percent of total aldehyde that is not with urea or a urea derivative.

The urea-aldehyde resins may comprise urea or any urea derivative and any aldehyde that are capable of being rendered coatable and will react together in the presence of a Lewis acid catalyst and which afford an abrasive product with acceptable abrading performance. The resins are preferably 30-95% solids, more preferably 60-80% solids, with a viscosity in the range from about 125 to 1500 cps (0.125 to 1.5 Pa.s) (BROOKFIELD viscometer, number 3 spindle, 30 rpm, 25° C.) before addition of water and have a molecular weight (number average) of at least about 200, preferably about 200 to 700.

The invention contemplates not only use of urea, H₂NCONH₂, but also straight and branched chain and cyclic urea derivatives, provided that they have at least one functional group that is reactive with aldehyde. Urea is preferred, but in some instances it may be desirable to replace some or all of the urea with a urea derivative to modify physical properties of the product. Useful urea derivatives include those of formula (I)

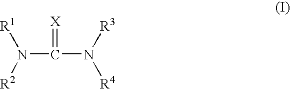

and mixtures thereof, wherein X is O or S, and each of R¹, R², R³ and R⁴ is hydrogen, C₁₋₁₀ alkyl, C₂₋₄ hydroxyalkyl having one or more hydroxy groups or hydroxypolyalkyleneoxy having one or more hydroxyl groups, with the provisos that:

(i) the compound contains at least one —NH group and one —OH group or at least two —OH groups or at least two —NH groups;

(ii) R¹ and R² or R¹ and R³ can be linked to form a ring structure;

(iii) R¹, R², R³ and R⁴ are not all hydrogen.

The urea-aldehyde resins may be “modified” or “unmodified”, as those terms are known or used in the art. The term “modified” denotes that the urea is modified by reaction, for example, with furfural, furyl alcohol and/or melamine prior to or during reaction with the aldehyde. The aqueous composition of the urea-aldehyde resin composition suitably has a pH in the range of about 6.0 to about 8.0.

A particularly preferred urea-aldehyde resin is available from Borden Chemical (North Bay, Ontario) under the trade designation AL-3029R. This is an unmodified (contains no furfural) urea-formaldehyde resin, 65% solids, viscosity (BROOKFIELD, #3 spindle, 30 rpm, 25° C.) of 325 cps (0.325 Pa.s), a free formaldehyde content of 0.1-5% and a mole ratio of formaldehyde to urea (“F/U ratio”) in the range of about 1.4 to about 1.6. Other suitable urea-aldehyde resins include those available from Borden Chemical (Sheboygan, Wis.) under the trade designations AL-8401 and AL-8405.

Another component of the binder precursor composition is a reactant bearing carboxylic acid groups or derivatives thereof, which is compatible with the spraying process of this invention.

The derivatives of carboxylic acid groups that are suitably used in this invention are those which are reactive (i.e., not sterically hindered), or those which can readily undergo hydrolysis.

The derivatives of carboxylic acid groups preferably have a terminal group of the formula (II):

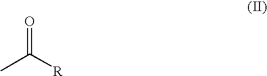

where R is a —OR¹, —OC(O)R¹, or —NHR¹ group, or is a halogen, preferably Cl or Br, and R¹ is a C₁-C₈ branched or unbranched alkyl group, preferably methyl or ethyl, a C₃-C₈ cycloalkyl group, preferably a cyclopentyl or cyclohexyl group, a C₆-C₁₀ aryl group (e.g. phenyl or naphthyl group), or a C₄-C₉ heteroaryl group, the heteroatom being O, S, or N.

The reactant bearing carboxylic acid groups or derivatives thereof is preferably a reactant bearing carboxylic acid groups, a reactant bearing esters of carboxylic acid or alcohol groups, a reactant bearing anhydride groups, or a reactant bearing carboxylic acid groups and one or more other groups selected from the group consisting of esters of carboxylic acid or alcohol groups, anhydrides, acyl halides and amides. The reactant bearing carboxylic acid groups or derivatives thereof is most preferably a reactant bearing carboxylic acid groups.

The reactant bearing carboxylic acid groups or derivatives thereof is suitably a polymer/oligomer bearing carboxylic acid groups or derivatives thereof. As another preferred feature, this polymer has a glass transition temperature in the range of from about −20° C. to 17° C. The polymer may be a homopolymer of a monomer bearing a carboxylic acid group or a derivative thereof, or a copolymer of i) a monomer bearing a carboxylic acid group or a derivative thereof and ii) other c6polymerisable monomers, which do not interfere with the progress of the curing step of the process of this invention.

The polymer is preferably a (meth)acrylate polymer, a (meth)acrylate-(meth)acrylamide copolymer, an ethylene-vinyl acetate copolymer or mixtures thereof. The term “(meth)acrylate”, as used herein, is meant to encompass both (meth)acrylic acid and lower alkyl esters thereof, preferably methyl or ethyl esters.

The polymer is preferably in the form of an aqueous dispersion, i.e. a latex. Examples of suitable, commercially-available latexes include latexes comprising ethylene-vinyl acetate copolymers such as those available under the trade designations AIRFLEX 410 and AIRFLEX 108 (available from Air Products Inc., Allentown, Pa.), latexes comprising (meth)acrylate-(meth)acrylamide copolymers such as those available under the trademarks HYCAR 2679 (available from B. F. Goodrich Co., Avon Lake, Ohio), and latexes comprising (meth)acrylate polymers, for example RHOPLEX E-32NP and RHOPLEX TR-520 (available from Rohm & Haas, Bristol, Pa.). The AIRFLEX 410 and AIRFLEX 108 latexes are preferably used in admixture with one or more of the commercially available latexes listed above.

The reactant bearing carboxylic acid groups or derivatives thereof is preferably a self-crosslinking polymer, that is, it is capable of becoming crosslinked at elevated temperatures in the absence of an external cross-linking agent. For example, those available under the trade designations RHOPLEX TR-520 and RHOPLEX E-32NP will self cross-link when heated at 120-140° C. for at least 30 minutes.

The reactant bearing carboxylic acid groups or derivatives thereof may also be a monomeric carboxylic acid (e.g. acetic, adipic, oleic, or stearic acid).

Desirably, the reactant bearing carboxylic acid groups or derivatives thereof is admixed with the amine-aldehyde resin composition before being sprayed. As they are both soluble or dispersible in water, water is used as the solvent and use of volatile organic compounds (VOC's) is avoided. Preferably, the amount of the amine-aldehyde resin composition that is used is about 70-90 weight percent, based on the total weight of the reactant bearing carboxylic acid groups or derivatives thereof, the weight of the amine-aldehyde resin and the weight of Lewis acid. Preferably, the amount of reactant bearing carboxylic acid groups or derivatives thereof that is used is about 5 to 25 weight percent, more preferably about 10 to 20 weight percent, based on the total weight of the reactant bearing carboxylic acid groups or derivatives thereof, the weight of the amine-aldehyde resin and the weight of the Lewis acid.

As catalyst there is used a Lewis acid. A Lewis acid is defined as a compound that accepts an electron pair. Preferably, the Lewis acid has an aqueous solubility at 15° C. of at least about 50 grams/cc. Suitable Lewis acids include aluminum chloride, iron(III)chloride and copper(II)chloride. The preferred Lewis acid is aluminum chloride in either its non-hydrated form, AlCl₃, or the hexahydrate AlCl₃.6H₂O. The Lewis acid is preferably used in an amount of about 0.1 to about 5 weight percent, preferably 0.25 to 4 weight percent, based on the total weight of the reactant bearing carboxylic acid groups or derivatives thereof, the weight of the amine-aldehyde resin and the weight of the Lewis acid. It is preferably used as a 20-30% by weight aqueous composition.

The composition of the invention can be subjected to thermal curing. The process of the invention permits the thermal curing of the binder composition at a lower temperature, and for a shorter time, than the prior art. In the prior art a curing temperature of at least about 75° C. for more than 10 minutes has been required, whereas satisfactory products have been obtained by the process of the invention after curing at a temperature of not greater than 65° C. for less than 10 minutes, and in some instances at a temperature of about 55° C., and for a significantly shorter time than required in the prior art. This is significant not only in terms of the cost of the process but also in terms of the properties of the product. The higher the temperature at which the abrasive product, say, coated abrasive is cured, and the longer the product is held at that temperature, the more brittle and inclined to curl is the product.

In the coated abrasive embodiments of the invention it is common and sometimes preferable to utilize a “nonloading” or “load-resistant” supersize coating. “Loading” is the term used in the abrasives industry to describe the filling of spaces between the abrasive particles with swarf (the material abraded form the workpiece) and the subsequent build-up of that material. For example, during wood sanding, swarf becomes lodged in the spaces between abrasive particles, dramatically reducing the cutting ability of the abrasive particles. Examples of such loading resistant materials include metal salts of fatty acids, urea-formaldehyde resins, waxes, mineral oils, crosslinked siloxanes, crosslinked silicones, fluorochemicals, and combinations thereof. A particularly preferred load resistant supersize coating is zinc stearate in a cellulosic binder.

Before an anti-loading agent can be applied to an abrasive product formed by a curing process, it is first necessary to ensure that curing of the product is completed. In cases where the curing is incomplete, it is either necessary to wait for a period of time (usually about 10 days at room temperature) before the anti-loading agent can be applied, or post-cure the product (usually at 110° C. for one hour) and wait for a shorter period of time (usually two days) before applying the agent. In the present invention, the product can be completely cured in the curing step, and can be directly treated with an anti-loading agent. The requirement for post-curing of the product and/or waiting before an anti-loading agent can be applied has, therefore, been eliminated in this invention. The present invention consequently provides a significant reduction in operational time.

Suitable abrasive particles for making coated and nonwoven abrasives include those made of flint, garnet, aluminum oxide, ceramic aluminum oxide, alumina zirconia (including fused alumina zirconia commercially available from the Norton Company of Worchester, Mass., under the trade designation NORZON), diamond, silicon carbide, alpha alumina-based ceramic material (available from Minnesota Mining and Manufacturing Company, St. Paul, Minn. under the trade designation CUBITRON), or mixtures thereof. Suitable abrasives can also be made according to techniques known in the art. For fused alumina-zirconia see U.S. Pat. Nos. 3,781,172 (Pett et al.); 3,891,408 (Rowse et al.); and 3,893,826 (Quinan et al.); for refractory coated silicon carbide see U.S. Pat. No. 4,505,720 (Gabor et al.); for alpha alumina-based ceramic material see U.S. Pat. Nos. 4,314,827 (Leitheiser et al.); 4,518,397 (Leitheiser et al.); 4,574,003 (Gerk); and 4,744,802 (Schwabel); 4,770,671 (Monroe et al.); and 4,881,951 (Monroe et al.). The disclosures of these U.S. patents are incorporated herein by reference. The abrasive particles may be individual. abrasive grains or agglomerates of individual abrasive grains. The frequency (concentration) of the abrasive grains on the backing is within the competence of the person skilled in the art. The abrasive grains can be oriented or can be applied to the backing without orientation, depending upon the requirements of the particular coated abrasive product.

The choice of abrasive particle type and size is somewhat dependent on the surface finish desired. The surface finish of the workpiece may be determined before and after abrasion by mounting the workpiece in the specimen holder of a profilometer instrument, such as that known under the trade designation RANK SURTRONIC 3, available from Rank Taylor-Hobson, Leicester, England. Rₜₘ, which is the mean of the maximum peak-to-valley values from each of 5 sampling lengths, is typically recorded for each test. It is desirous to produce a coated abrasive that exhibits an increase in cut while producing an acceptable surface finish on the workpiece.

The coatable binder precursor compositions of the present invention can contain fillers, fibers, lubricants, grinding aids, wetting agents, and other additives such as surfactants, pigments, dyes, coupling agents, plasticizers, and suspending agents. The amounts of these materials are selected to give the properties desired. Alternatively, the binder precursor compositions of the invention may be formulated without these additives, and the additives mixed into the binder precursor just prior to spraying onto a substrate.

Fillers are frequently used in abrasive articles to reduce cost and improve dimensional stability and other physical characteristics. Fillers can be selected from any filler material that does not adversely affect the rheological characteristics of the binder precursors or the abrading performance of the resulting abrasive article. Preferred fillers include calcium metasilicate, aluminum sulfate, alumina trihydrate, cryolite, magnesia, kaolin, quartz, and glass. Fillers that function as grinding aids are cryolite, potassium fluoroborate, feldspar, and sulfur. Fillers can be used in varying amounts limited only by the proviso that the abrasive article retains acceptable mechanical properties (such as flexibility and toughness).

Thereafter the abrasive product may be further treated, for instance, with additives to reduce dust loading of the abrasive product during use. Such additives, and their application, are well known, calcium stearate being one such example.

Typically and preferably a solvent is added as needed to render the binder precursor compositions of the invention coatable. The solvent is preferably water, but those skilled in the art will realize with minimal experimentation, whether an organic solvent may be necessary, depending on the coating method, aldehyde, urea derivative, and the like. When water is used solely as the solvent it is preferably added up to the water solubility tolerance of the binder precursor solution, although this is not necessary to render the compositions of the invention coatable. A water tolerance greater than about 100% is preferred, greater than about 150% especially preferred. “Water tolerance” is defined as the measurement of the maximum weight percent of distilled water, based on initial resin weight, which can be added to a stirred, uncured resin via titration to begin causing visual phase separation (as evidenced by milky appearance) of the resin/water mixture into aqueous and organic phases.

Coated abrasive articles that may be produced by incorporating cured versions of the coatable binder precursor compositions of the invention typically include a flexible backing, such as paper sheet, cloth fabric, nonwoven substrates, vulcanized fiber, polymeric film, and combinations and treated versions thereof. The untreated backing may optionally be treated with saturant, backsize, and/or presize coatings. For a treated cloth backing there is preferably no clear line of demarcation between the saturant coating, backsize coating and the presize coating which meet in the interior of the cloth backing which is saturated as much as possible with the resins of these coatings.

Typical saturant coatings may include acrylic latices, natural rubber, thermally curable resins, and the urea-aldehyde resins described above. Backsize and presize coatings may also comprise the urea-aldehyde resins described herein.

A make coating is then coated onto the untreated or treated backing, and before the make coating is cured, abrasive particles are deposited thereon. Preferably, the make coating is partially cured or gelled after application of abrasive particles and before application of a size coating.

Coated abrasive articles made in accordance with this invention can also include such modifications as are known in this art. For example, a back coating such as a pressure-sensitive adhesive (PSA) can be applied to the non-abrasive side of the backing, and various supersize coatings, such as zinc stearate, can be applied to the abrasive surface to prevent abrasive loading; alternatively, the supersize coating can contain grinding aids to enhance the abrading characteristics of the coated abrasive, or a release coating to permit easy separation of PSA from the coated abrasive surface in cases where the coated abrasive is in the form of a roll of abrasive sheets, as illustrated in U.S. Pat. No. 3,849,949 (Steinhauser, et al.), incorporated by reference herein.

Representative PSAs useful for abrasive articles of the invention include latex crepe, rosin, acrylic polymers and copolymers such as polybutylacrylate and the like, polyacrylate esters, vinyl ethers such as polyvinyl n-butyl ether and the like, alkyd adhesives, rubber adhesives such as natural rubber, synthetic rubber, chlorinated rubber, and the like, and mixtures thereof. A particularly preferred type of PSA is a copolymer of isooctylacrylate and acrylic acid.

In the manufacture of coated abrasive articles of the invention, the coatable binder precursor compositions of this invention, when cured, can be used as a treatment coating for the backing, e.g., cloth, paper, or plastic sheeting, to saturate or provide a back coating (backsize coating) or front coating (presize coating) thereto, as a make coating to which abrasive grains are initially anchored, as a size coating for tenaciously holding abrasive grains to the backing, or for any combination of the aforementioned coatings. In addition, the coatable binder precursor compositions of this invention, when cured, can be used in coated abrasive article embodiments where only a single-coating binder is employed, i.e., where a single-coating takes the place of a make coating/size coating combination.

When the coatable binder precursor compositions of the present invention are applied to a backing in one or more treatment steps to form a treatment coating, the treatment coating can be cured thermally by passing the treated backing over a heated drum; there is no need to festoon cure the backing in order to set the treatment coating or coatings. After the backing has been properly treated with a treatment coating, the make coating can be applied. After the make coating is applied, the abrasive grains are applied over the make coating. Next, the make coating, now bearing abrasive grains, is exposed to a heat source which generally solidifies or sets the binder sufficiently to hold the abrasive grains to the backing. Then the size coating is applied, and the size coating/abrasive grain/make coating combination is exposed to a heat source, preferably an oven cure. This process will substantially cure or set the make and size coating used in the coated abrasive constructions.

The coatable binder precursor compositions of the present invention, when cured, only need to be in at least one of the binder layers, i.e., treatment coating, make coating, size coating, comprising the coated abrasive article. It does not need to be in every binder layer; the other binder layers can utilize various other binders known in the art, such as epoxy resin-based binders. If the binder of the present invention is in more than one layer, the curing conditions do not need to be the same for curing each layer of the coated abrasive.

Test Methods

The following test methods were used to characterize the compositions and articles of the invention.

Peak Exotherm Temperature

Differential scanning calorimetry (DSC) thermograms of samples of binder precursor compositions were obtained with a DSC machine known under the trade designation SERIES 9990 DIFFERENTIAL THERMAL ANALYZER, from E. I. du Pont de Nemours & Co., Wilmington, Del. (“du Pont”). The machine was operated at a heating rate of 10° C./min over a temperature range of 20°-140° C. The binder precursors tested were weighed and mixed in a separate container. A small amount of the binder precursor to be tested (50-90 mg) was then placed in a large volume capsule, and the capsule immediately hermetically sealed. A sealed capsule containing the binder precursor to be tested was then placed in the machine and heated at the rate mentioned above to determine the peak exotherm temperature, which appeared as a maximum temperature peak on a chart readout. Differential scanning calorimetry is described generally in the article by Watson et al., A Differential Scanning Calorimeter for Quantitative Differential Thermal Analysis, Anal. Chem., Vol. 36, No. 4, pp. 1233-1238 (June, 1964).

Gel Time Measurement at 21-100° C.

Gel time gives an indirect measurement of the degree of polymerization at a particular catalyst level. The lower the gel time the more advanced in molecular weight the resin is considered to be. A commercially available gel time apparatus known by the trade designation SUNSHINE GELMETER available from Sunshine Co., was used in each measurement. For comparison, a control sample is tested under the same conditions. This gel time measuring apparatus is a torsion apparatus, wherein a glass rod (typically approximately 168 mm long by 6.35 mm diameter) is attached at one end via a chuck to a torsion wire (approximately 0.254 mm diameter music wire, available from Sunshine Co.), with the torsion wire in turn attached to a drive mechanism via a magnetic coupling so that the wire/glass rod combination hang vertically from the drive mechanism. About 2.81 cm of wire existed between the chuck and the magnetic coupling. A test tube (150 X 18 mm) was filled to about 65 mm depth with the resin to be tested (originally at 25° C.±3° C.), and the tube placed in a water bath which was at 21-100° C. The glass rod was lowered into the resin with the lower end of the glass rod about 6.35 mm from the tube bottom, and so that the resin level in the tube was below the water bath level. The glass rod/torsion wire were then rotated in the bath by the drive mechanism. As this combination was rotated a projection extending from the chuck connecting the glass rod and torsion wire also rotated, finally touching a similar, stationary projection extending from the machine. The gap between the projections was originally set at a value between 2 and 3 mm for each test. The time required for the rotating projection to touch the stationary projection was recorded as the gel time for each resin.

DRY SCHIEFER TEST

This test provided a measure of the cut (material removed from a workpiece) and finish (the relative quality of the abraded surface) of coated abrasive articles under dry conditions (about 22° C. and about 45% Relative Humidity).

A 10.16 cm diameter circular specimen was cut from the abrasive material tested and secured by a pressure-sensitive adhesive (3M Industrial Tape #442 double adhesive tape) to a back-up pad. The back-up pad was secured to the driven plate of a SCHIEFER ABRASION TESTER (available from Frazier Precision Company, Gaithersburg, Md.). Doughnut shaped cellulose acetate butyrate plastic workpieces, 10.16 cm outside diameter, 5.24 inside diameter, 1.27 cm thick, available plastic from Sielye Plastics, Bloomington, Minn. were employed as workpieces. The initial weight of each workpiece was recorded to the nearest milligram prior to mounting on the workpiece holder of the abrasion tester. A 4.54 kg weight was placed on the abrasion tester weight platform and the mounted abrasive specimen lowered onto the workpiece and the machine turned on. The machine was set to run for 500 cycles and then automatically stop. After each 500 cycles of the test, the workpiece was wiped free of debris and weighed. The cumulative cut for each 500-cycle test was the difference between the initial weight and the weight following each test.

### EXAMPLE 1 (COMPARATIVE)

Six catalysts were individually tested with three different urea-formaldehyde (UF) resins (obtained under the trade designations AL-3029, AL-8401, and AL-8405 from Borden Chemical). Each of the catalysts was used in an amount of 1.0 weight percent, based on the total weight of the UF resin and the catalyst, with the exception of the BF₃ catalyst, which was used in an amount of 0.5 weight percent, based on the total weight of the UF resin and the catalyst. Table 1 outlines the test results obtained by curing these UF resins with different catalysts. The BWG (Boiling Water Gelltime) is the gel time measured at 100° C. The values of TpK (peak exotherm temperature) were determined by DSC (Differential Scanning Calorimetry) conducted at a heating rate of 10° C./min.

The system comprising AlCl₃ as catalyst and AL-3029 as UF resin resulted in a cured resin displaying the best combination of gel time and value of TpK(° C.) compared to the values obtained from the cured resins produced by the other systems.

TABLE 1
Values of BWG and TpK(° C.) for UF resins AL-3029, AL-8401,
and AL-8405 cured with different catalysts

| | AL-3029 | | AL-8401 | | AL-8405 | |
|---|---|---|---|---|---|---|
| | UF resin | | UF resin | | UF resin | |
| Catalyst | BWG(sec) | TpK(° C.) | BWG(sec) | TpK(° C.) | BWG(sec) | TpK(° C.) |
| AlCl₃ | 36.0 | 70.9 | 35.8 | 77.0 | 43.2 | 109.9 |
| Al₂(SO₄)₃ | 45.1 | 79.8 | 51.9 | 85.7 | 68.3 | 120.4 |
| NH₄Cl | 70.7 | 91.3 | 46.5 | 72.8 | 67.0 | 91.1 |
| NH₄F | 91.5 | 97.0 | 78.2 | 91.9 | 126.0 | 104.6 |
| H₃BO₃ | NR | 140+ | NR | 140+ | NR | 140+ |
| BF₃ | 56.3 | 82.9 | 40.6 | 76.0 | 133.2 | 140+ |

### EXAMPLE 2 (COMPARATIVE)

UF resin AL-3029 was cured using concentrations of catalyst ranging from 0 to 4.00 weight percent, based on the total weight of the UF resin and the catalyst, at values of pH of 6.5, 5.5, and 4.5. The pH of the resin was adjusted using an 0.1 N aqueous solution of hydrochloric acid. A 28% solids aqueous solution of AlCl₃ was used in the experiments described in this example. Table 2 shows the results of these studies.

TABLE 2
Effect of catalyst concentration and the value of pH of the resin
on the values of BWG and TpK(° C.) of the cured AL-3029 UF resin

| | pH(resin) = 6.5 | | pH(resin) = 5.5 | | pH(resin) = 4.5 | |
|---|---|---|---|---|---|---|
| AlCl₃(wt %) | BWG(sec) | TpK(° C.) | BWG(sec) | TpK(° C.) | BWG(sec) | TpK(° C.) |
| 0.00 | >20 mins | 135.9 | 978.2 | 119.1 | 172.4 | 100.4 |
| 0.25 | 51.8 | 80.5 | 48.8 | 79.7 | 44.7 | 77.0 |
| 0.50 | 41.0 | 74.0 | 39.3 | 71.5 | 38.7 | 73.1 |
| 1.00 | 38.8 | 71.3 | 34.4 | 69.7 | 33.3 | 70.8 |
| 2.00 | 34.8 | 67.3 | 32.3 | 68.4 | 31.1 | 68.3 |
| 4.00 | 31.4 | 72.2 | 27.0 | 72.7 | 26.3 | 70.9 |

### EXAMPLE 3 (COMPARATIVE)

This example illustrates the effect of latex type, and concentration of silica filler having the trade designation MINSPAR-3 (available from K-T Feldspar Corp., Spruce Pine, N.C.) on the performance of the AL-3029 urea-formaldehyde resin.

Two kinds of vinyl acetate-ethylene latex (obtained under the trade designations AIRFLEX 410 & AIRFLEX 108 from Air Products Co.) and three kinds of acrylic latex (obtained under the trade designations Hycar 2679 from B F Goodrich, and RHOPLEX E-32NP & RHOPLEX TR-520 from Rohm & Haas Co) were evaluated in the AL-3029 urea-formaldehyde resin at filler levels of 0, 20, and 40 weight percent, based on the total weight of UF resin and catalyst. AlCl₃ was used as the catalyst and was used in an amount of 1.0 weight percent based on the weight of UF resin and catalyst. All latex levels were fixed at 20% solid per 100% solid UF resin. Table 3 shows the test results obtained using different latexes and percentages of fillers. It has been determined by FT-IR that carboxylic acid groups are among the functional groups present in the RHOPLEX E-32NP and TR520 acrylic latexes.

TABLE 3
Effect of latex type and filler concentration on the properties
of cured AL-3029 urea-formaldehyde resin

| | 0% Filler | | 20% Filler | | 40% Filler | |
|---|---|---|---|---|---|---|
| Latex Type | BWG(sec) | Tpk(° C.) | BWG(sec) | Tpk(° C.) | BWG(sec) | Tpk(° C.) |
| Glycerol | 41.7 | 72.6 | 42.3 | 71.3 | 36.7 | 71.4 |
| AIRFLEX | 37.9 | 70.4 | 37.1 | 69.5 | 35.3 | 69.0 |
| 410 | | | | | | |
| AIRFLEX | 38.5 | 70.4 | 35.6 | 70.0 | 33.4 | 68.5 |
| 108 | | | | | | |
| HYCAR | 39.2 | 71.1 | 34.8 | 70.7 | 33.2 | 70.6 |
| 2679 | | | | | | |
| RHOPLEX | 39.7 | 69.0 | 41.7 | 70.3 | 36.2 | 70.7 |
| E-32NP | | | | | | |
| RHOPLEX | 32.9 | 65.9 | 34.8 | 66.5 | 29.4 | 66.2 |
| TR-520 | | | | | | |

### EXAMPLE 4

The gel times of an example of a binder precursor formulation of the invention (Formulation A) and a control formulation (product code EX), which was Example 8 of U.S. Pat. No. 5,486,219, were measured at different temperatures (Table 4).

TABLE 4
Composition of an example of the binder precursor formulation
of the invention and of the control formulation

| Binder Precursor Formulation of the Invention | | | |
|---|---|---|---|
| (Formulation A) | | Control Formulation | |
| | wt. % of total | | wt. % of total |
| Component | composition | Component | composition |
| AL-3029 | 79.6 | AL-3029R | 87.2 |
| (65% solids) | | (65% solids) | |
| RHOPLEX TR-520 | 10.4 | NH₄Cl | 4.7 |
| (50% solids) | | (25% solids) | |
| AlCl₃ | 1.8 | AlCl₃ | 0.6 |
| (28% solids aqueous solution) | | (28% solids aqueous solution) | |
| H₂O | 8.2 | H₂O | 7.5 |

Table 5 outlines the test results of the gel time study between the control formulation and an example of the binder precursor formulation of the invention (Formulation A).

TABLE 5
Results of the gel time of the control formulation and an example of the binder
precursor formulation of the invention (Formulation A) as a function of temperature

| | Gel time of | Gel time of | |
|---|---|---|---|
| Temperature of Gel | Control Formulation | Invention Formulation | Decrease |
| Time Measurement | (minutes) | (minutes) | (%) |
| 21° C. | 146.5 | 29.6 | 395 |
| 30° C. | 44.5 | 13.8 | 222 |
| 40° C. | 16.1 | 5.6 | 188 |
| 50° C. | 6.8 | 2.5 | 176 |
| 60° C. | 3.2 | 1.9 | 75 |
| 70° C. | 2.0 | 1.5 | 39 |

### EXAMPLE 5

Backing paper previously untreated with a size coat, product code EX, was spray coated with a control formulation or with the binder precursor formulation of the invention as a size coat, and then coated with grade p-180 aluminum oxide abrasive particles, a heat treated fused aluminum oxide abrasive grain, FEPA grade 180, commercially available from Treibacher, Villach, Austria, under the trade designation ALODUR BFRP. The size coat was cured at various oven temperatures for 30 minutes and left at room temperature for 72 hours before the Dry Schiefer test was conducted on the coated paper. Results are given in Table 6.

TABLE 6
Results of the Dry Schiefer Test on samples of sandpaper prepared with
either the control formulation or the binder precursor formulation of the
invention

| Cure Temperature | Control cut (gm) | Invention cut (gm) | Increase (%) |
|---|---|---|---|
| 50° C. | 0.685 | 1.695 | 147 |
| 60° C. | 1.003 | 1.864 | 86 |
| 70° C. | 1.684 | 1.948 | 16 |
| 80° C. | 2.126 | 2.167 | 2 |

### EXAMPLE 6

Backing paper previously untreated with a size coat, product code EX, was spray coated with the control formulation or with the binder precursor formulation of the invention as a size coat, and then coated with grade p-180 aluminum oxide abrasive particles. The size coat was cured at various oven temperatures for 30 minutes and left at room temperature for 72 hours. The coated paper was then further coated with a calcium stearate (FC 6) supersize coating (coated at about 7.0 gn/4×6″ (29.3 g/m²) (wet), and cured for 30 seconds at 100° C.) before the Dry Schiefer test was conducted on the coated paper. The composition of FC-6, on a dry weight basis was:

(a) 89.6% calcium stearate, available as an aqueous dispersion from Henkel Canada Ltd., Mississauga, Ontario, under the trade designation NOPCOTE;

(b) 9.69% acrylic resin, available from B. F. Goodrich Co., Cleveland, Ohio, under the trade designation CARBOSET-GA-1087; and

(c) 0.71% antifoam, available from Hercules, Inc., Savannah, Ga., under the trade designation ADVANTAGE 1512.

Table 7 provides the test results.

TABLE 7
Results of the Dry Schiefer test on samples of sandpaper prepared
with either the control formulation or the binder precursor composition
of the invention, and a calcium stearate supersize coating (FC 6)

| Cure | Control | Invention | |
|---|---|---|---|
| Temperature | cut (gm) | (gm) | Increase (%) |
| 50° C. | 1.381 | 3.046 | 121 |
| 60° C. | 2.630 | 3.101 | 18 |
| 70° C. | 2.856 | 3.086 | 8 |
| 80° C. | 3.026 | 3.157 | 4 |

Various modifications and alterations of this invention will become apparent to those skilled in the art without departing from the scope and spirit of this invention, and it should be understood that this invention is not to be unduly limited to the illustrative embodiments set forth herein.

1. A process for coating a surface which comprises applying a composition comprising an amine-aldehyde resin, a reactant bearing carboxylic acid groups or derivatives thereof, and a Lewis acid onto the surface, and curing the composition.

2. A process according to claim 1, wherein components of the composition are mixed by spraying an amine-aldehyde resin composition, a composition of a reactant bearing carboxylic acid groups or derivatives thereof and a composition of a Lewis acid onto the surface.

3. A process according to claim 2, wherein there are sprayed three compositions, one composition containing the amine-aldehyde resin, a second composition containing the reactant bearing carboxylic acid groups or derivatives thereof, and a third composition containing the Lewis acid.

4. A process according to claim 2, wherein there are sprayed two compositions, one composition containing the amine-aldehyde resin and the reactant bearing carboxylic acid groups or derivatives thereof, and the other composition containing the Lewis acid.

5. A process according to claim 2, wherein there are sprayed two compositions, one composition containing the amine-aldehyde resin and the other composition containing said reactant and the Lewis acid.

6. A process according to claim 1, wherein said reactant bearing carboxylic acid groups or derivatives thereof is a self-crosslinking polymer.

7. A process according to claim 1, wherein said reactant is a polymer having a glass transition temperature in the range from about −20° C. to 17° C.

8. A process according to claim 1, wherein said reactant bears carboxylic acid groups.

9. A process according to claim 1, wherein said reactant bears carboxylic acid groups and one or more other groups selected from the group consisting of esters, anhydrides and amides.

10. A process according to claim 1, wherein said reactant bears ester groups.

11. A process according to claim 1, wherein said reactant is a latex comprising a (meth)acrylate polymer, a (meth)acrylate-(meth)acrylamide copolymer, an ethylene-vinyl acetate copolymer, or mixtures thereof.

12. A process according to claim 1, wherein the amount of said reactant is in the range of from about 5 to 25 percent by weight, based on the total weight of said reactant, the weight of the amine-aldehyde resin and the weight of Lewis acid.

13. A process according to claim 1, wherein the amount of the amine-aldehyde resin used is in the range of about 70 to 90 weight percent based on the total weight of said reactant, the weight of the amine-aldehyde resin and the weight of Lewis acid.

14. A process according to claim 1, wherein the amine-aldehyde resin has a ratio of aldehyde: amine in the range from about 1.0:1 to 2:1.

15. A process according to claim 1, wherein the amine-aldehyde resin is a urea-formaldehyde resin.

16. A process according to claim 1, wherein the Lewis acid is aluminum chloride.

17. A process according to claim 1, wherein thermal curing of the coated composition at a temperature not greater than 65° C. is effected.

18. A process for preparing an abrasive product, wherein a coating of a composition comprising an amine-aldehyde resin, a reactant bearing carboxylic acid groups or derivatives thereof, and a Lewis acid is applied to a surface of a backing strip by a process according to claim 1, to serve as a make composition and abrasive particles are deposited on the backing strip.

19. A process according to claim 18, wherein a further coating of the composition is applied by a process according to claim 1 to serve as a size composition.

20. A coated abrasive having a binder and abrasive particles attached to a backing, wherein at least one layer of the binder comprises a cured binder derived from a coatable binder precursor composition comprising an amine-aldehyde resin, a reactant bearing carboxylic acid groups or derivatives thereof and a Lewis acid.

21. A coated abrasive according to claim 20, wherein said reactant is a self-crosslinking polymer.

22. A coated abrasive according to claim 20, wherein said reactant is a polymer having a glass transition temperature in the range from about −20° C. to 17° C.

23. A coated abrasive according to claim 20, wherein said reactant bears carboxylic acid groups.

24. A coated abrasive according to claim 20, wherein said reactant bears carboxylic acid groups, and one or more other groups selected from the group consisting of esters, anhydrides and amides.

25. A coated abrasive according to claim 20, wherein said reactant bears ester groups.

26. A coated abrasive according to claim 20, wherein said reactant is a latex comprising a (meth)acrylate polymer, a (meth)acrylate-(meth)acrylamide copolymer, an ethylene-vinyl acetate copolymer, or mixtures thereof.

27. A coated abrasive according to claim 20, wherein the amount of said reactant is in the range of from about 5 to 25 percent by weight, based on the total weight of said reactant, the weight of the amine-aldehyde resin and the weight of Lewis acid.

28. A coated abrasive according to claim 20, wherein the amount of the amine-aldehyde resin composition used is in the range of about 70 to 90 weight percent based on the total weight of said reactant, the weight of the amine-aldehyde resin and the weight of Lewis acid.

29. A coated absrasive according to claim 20, wherein the amine-aldehyde resin has a molar ratio of aldehyde: amine in the range from about 1.0:1 to 2:1.

30. A coated abrasive according to claim 20, wherein the amine-aldehyde resin is a urea-formaldehyde resin.

31. A coated abrasive according to claim 20, wherein the Lewis acid is aluminum chloride.

32. A coated abrasive according to claim 20, wherein said at least one layer is a make coating.

33. A coated abrasive according to claim 20, wherein said at least one layer comprises make and size coatings.

34. A coated abrasive according to claim 20, which includes a load-resistant supersize coating.

35. A coated abrasive according to claim 20, which includes a pressure-sensitive adhesive backsize coating.

36. A coated abrasive according to claim 20, wherein said cured binder has blended therein a filler.

37. A process for making a coated abrasive article comprising:
(a) applying a first layer comprising a first curable composition onto a surface of a backing;
(b) at least partially embedding abrasive grains into the first layer;
(c) at least partially curing the first curable composition;
(d) applying a second layer comprising a second curable composition over the at least partially cured first curable composition and abrasive grains; and
(e) curing the second curable composition
wherein at least one of the first or second curable compositions is a binder precursor composition comprising an amine-aldehyde resin, a reactant bearing carboxylic acid groups or derivatives thereof, and a Lewis acid.

38. A process according to claim 37, wherein components of said binder precursor composition are mixed by spraying an amine-aldehyde resin composition, a composition of a reactant bearing carboxylic acid groups or derivatives thereof and a composition of a Lewis acid onto the surface.

39. A process according to claim 38, wherein there are sprayed three compositions, one composition containing the amine-aldehyde resin composition, a second composition containing the reactant bearing carboxylic acid groups or derivatives thereof, and a third composition containing the Lewis acid.

40. A process according to claim 38, wherein there are sprayed two compositions, one composition containing the amine-aldehyde resin composition and the reactant bearing carboxylic acid groups or derivatives thereof, and the other composition containing the Lewis acid.

41. A process according to claim 38, wherein there are sprayed two compositions, one composition containing the amine-aldehyde resin composition and the other composition containing the reactant bearing carboxylic acid groups or derivatives thereof and the Lewis acid.

42. A process according to claim 37, wherein said reactant is a self-crosslinking polymer.

43. A process according to claim 37, wherein said reactant is a polymer having a glass transition temperature in the range from about −20° C. to 17° C.

44. A process according to claim 37, wherein said reactant bears carboxylic acid groups.

45. A process according to claim 37, wherein said reactant bears carboxylic acid groups and one or more other groups selected from the group consisting of esters, anhydrides and amides.

46. A process according to claim 37, wherein said reactant bears ester groups.

47. A process according to claim 37, wherein said reactant is a latex comprising an (meth)acrylate polymer, a (meth)acrylate-(meth)acrylamide copolymer, an ethylene-vinyl acetate copolymer, or mixtures thereof.

48. A process according to claim 37, wherein the amount of said reactant is in the range of from about 5 to 25 percent by weight, based on the total weight of said reactant, the weight of the amine-aldehyde resin and the weight of the Lewis acid.

49. A process according to claim 37, wherein the amount of the amine-aldehyde resin composition used is in the range of about 70 to 90 weight percent based on the total weight of said reactant and the weight of the amine-aldehyde solids.

50. A process according to claim 37, wherein the amine-aldehyde resin has a molar ratio of aldehyde: urea in the range from about 1.0:1 to 2:1.

51. A process according to claim 37, wherein the amine-aldehyde resin is a urea-formaldehyde resin.

52. A process according to claim 37, wherein the Lewis acid is aluminum chloride.

53. A process according to claim 37, wherein thermal curing of the curable composition at a temperature not greater than 65° C. is effected.

54. A process according to claim 37, which includes the application of a load-resistant supersize coating to the backing.

55. A process according to claim 37, which includes the application of a pressure-sensitive adhesive backsize coating to the backing.
